(19) United States
(12) Patent Application Publication
(10) Pub. No.: US 2025/0260792 A1
(43) Pub. Date: Aug. 14, 2025

(54) DISPLAY DEVICE AND DISPLAY CONTROL METHOD

(71) Applicant: Sharp NEC Display Solutions, Ltd., Tokyo (JP)

(72) Inventor: Tomoyuki KAJI, Tokyo (JP)

(21) Appl. No.: 19/169,759

(22) Filed: Apr. 3, 2025

Related U.S. Application Data
(63) Continuation of application No. PCT/JP2022/038162, filed on Oct. 13, 2022.

(51) Int. Cl. H04N 9/31

(52) U.S. Cl. CPC H04N 9/3135; H04N 9/3182

(57) ABSTRACT

A display device includes a first storage configured to store post-processing parameter information obtained by processing parameter information indicating parameters for causing a light source device to appropriately emit light, a second storage configured to store processing information specific to the light source device, a processor configured to process the post-processing parameter information stored in the first storage into pre-processing parameter information based on the processing information stored in the second storage, and a light source controller configured to cause the light source device to emit light based on the pre-processing parameter information processed by the processor.

### TECHNICAL FIELD

The present invention relates to a display device and a display control method.

### BACKGROUND ART

In recent years, as a method of purchasing a projector, a method of purchasing a license according to an amount of time the projector is to be used, instead of purchasing the projector itself at a regular price, has been provided. In this method, the purchaser pays in advance an amount of money according to the amount of time the projector is to be used, and purchases a license that allows the projector to be used for that amount of time. The seller provides the purchaser with a projector that has the license purchased by the purchaser written to it. This allows the purchaser to use the projector for the amount of time the license is purchased.

In this manner, a function of allowing the projector to be used based on a license can also be implemented for existing projectors that can be used even without licenses written to them. However, when a component that has a license and software for executing this function written to it is replaced with a component that does not have the license and software written to it, it becomes possible to use the projector while ignoring a usable time indicated by the license.

Therefore, various technologies have been proposed that detect replacement of a component to disable a use of the projector. For example, Patent Document 1 listed below discloses a technology that, when it is detected that a projection light source in a projector has been replaced with a projection light source that is not a genuine standard product, controls the projector so that the light cannot be turned on.

### CITATION LIST

### Patent Document

Patent Document 1: Japanese Unexamined Patent Application, First Publication No. 2008-185712

### SUMMARY OF INVENTION

### Technical Problem

However, with the technology of Patent Document 1, when the replaced component of the projector is a genuine standard component, the projector can be used illegally even if the component does not have a license written to it.

In consideration of the problems described above, an object of the present invention is to provide a display device and a display control method that can prevent unauthorized use.

### Solution to Problem

To solve the problems described above, a display device according to one aspect of the present invention includes a first storage configured to store post-processing parameter information obtained by processing parameter information indicating parameters for causing a light source device to appropriately emit light, a second storage configured to store processing information specific to the light source device, a processor configured to process the post-processing parameter information stored in the first storage into pre-processing parameter information based on the processing information stored in the second storage, and a light source controller configured to cause the light source device to emit light based on the pre-processing parameter information processed by the processor.

A display control method according to another aspect of the present invention includes a first storage process for storing post-processing parameter information obtained by processing parameter information indicating parameters for causing a light source device to appropriately emit light, a second storage process for storing processing information specific to the light source device, a processing process for processing the post-processing parameter information stored in the first storage into pre-processing parameter information based on the processing information stored in the second storage, and a light source control process for causing the light source device to emit light based on the pre-processing parameter information processed by the processor.

### Advantageous Effects of Invention

According to the present invention, it is possible to prevent unauthorized use of a display device.

### BRIEF DESCRIPTION OF DRAWINGS

FIG. 1 A diagram representing an example of a configuration of a projector according to a first embodiment.

FIG. 2 A sequence diagram representing an example of a processing flow from registration of license information to processing of RGB values according to the first embodiment.

FIG. 3 A diagram representing an example of information stored in each storage in an initial state according to the first embodiment.

FIG. 4 A diagram representing an example of information stored in each storage after processing of RGB values according to the first embodiment.

FIG. 5 A sequence diagram representing an example of a processing flow from an input of a light emission request to light emission by the light source device according to the first embodiment.

FIG. 6 A diagram representing an example of information stored in each storage when the light source device emits light according to the first embodiment.

FIG. 7 A sequence diagram representing an example of a processing flow from an input of a light emission request to light emission by the light source device after replacement of a control board according to the first embodiment.

FIG. 8 A diagram representing an example of information stored in each storage when the control board is replaced according to the first embodiment.

FIG. 9 A diagram representing an example of information stored in each storage after the replacement of the control board according to the first embodiment and when the light source device emits light.

FIG. 10 A diagram representing an example of a configuration of a display device according to a second embodiment.

### DESCRIPTION OF EMBODIMENTS

Hereinafter, embodiments of the present invention will be described in detail with reference to the drawings.

In the present embodiment, a display device will be described using, as an example, a service in which a user can use a display device by purchasing a license instead of purchasing the display device itself at a regular price. In this service, a manufacturer of the display device sells the display device at a regular price to a business person providing the service (hereinafter also referred to as a “service provider”). The service provider sells the license of the display device purchased from the manufacturer to the user. The user purchases the license from the service provider according to an amount of time the display device is to be used. At this time, the user pays the service provider an amount of money according to the amount of time the display device is to be used. When the user purchases the license, the service provider writes information indicating the license that allows the display device to be used (hereinafter also referred to as “license information”) to the display device. As a result, the display device will be available for the amount of time for which the user purchases the license and be provided to the user.

In the following description, as an example, an example where the display device is a projector will be described.

### 1. First Embodiment

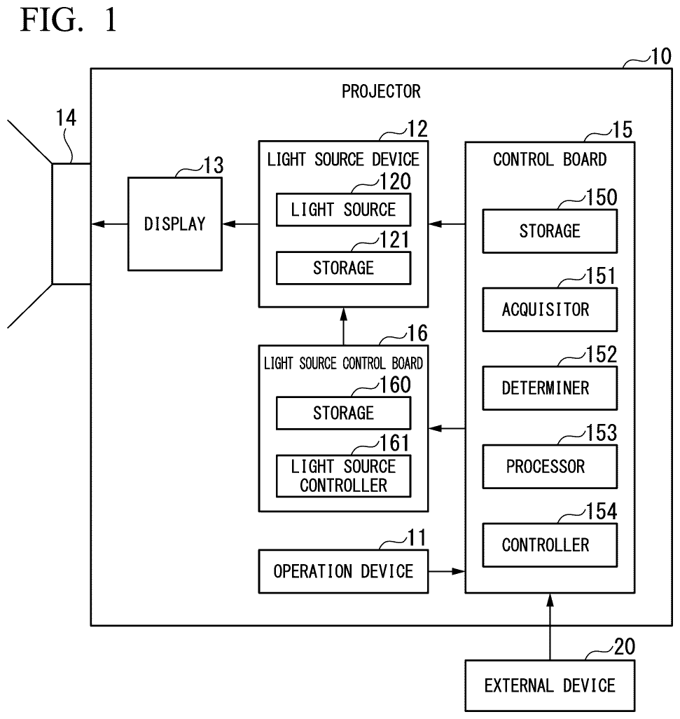

First, a first embodiment of the present invention will be described with reference to FIG. 1 to FIG. 9.

### 1-1. Configuration of Projector

A configuration of a projector according to the first embodiment will be described with reference to FIG. 1. FIG. 1 is a diagram which shows an example of the configuration of the projector according to the first embodiment of the present invention. As shown in FIG. 1, the projector 10 includes an operation device 11, a light source device 12, a display 13, a lens 14, a control board 15 (a first board), and a light source control board 16 (a second board).

### (1) Operation Device 11

The operation device 11 receives an input from a user. Examples of the operation device 11 include keys and buttons arranged on the projector 10, a remote controller, and various pointing devices. The user operates the operation device 11 to perform an input for operating the projector 10. For example, the user inputs an operation to cause the projector 10 to emit light (hereinafter also referred to as a “light emission operation”). When a light emission operation is performed, the operation device 11 inputs a light emission request to the control board 15.

### (2) Light Source Device 12

The light source device 12 is a device that emits light and irradiates with light.

As shown in FIG. 1, the light source device 12 includes a light source 120 and a storage 121 (a first storage).

### (2-1) Light Source 120

The light source 120 has, for example, a laser, a mercury lamp, a light emitting diode, or the like as a light source. In the following description, as an example, a case where the light source 120 has an RGB laser as a light source will be described. When an instruction to emit light is received, the light source 120 emits light and irradiates the display 13 with the emitted light. The light emission instruction is input from the light source control board 16.

### (2-2) Storage 121

The storage 121 stores parameter information indicating parameters for the light source device 12 to emit light appropriately. The parameter information is, for example, RGB values set so that the light source device 12 emits light with an appropriate white balance. The parameter information is information specific to the light source device 12. The parameter information is registered in the storage 121 by a manufacturer when the projector 10 is manufactured.

### (3) Display 13

The display 13 generates a display image based on a video signal and the light emitted by the light source 120, and displays it on a display panel such as a liquid crystal panel.

### (4) Lens 14

The lens 14 is an electric lens or a manual lens. The lens 14 projects the display image generated by the display 13 onto a projection surface.

### (5) Control Board 15

The control board 15 is a board that controls an overall operation of the projector 10.

As shown in FIG. 1, the control board 15 includes a storage 150 (a second storage), an acquisitor 151, a determiner 152, a processor 153, and a controller 154.

### (5-1) Storage 150

The storage 150 stores various types of information. The storage 150 stores a serial number, which is information for uniquely identifying the projector 10 and is information specific to the projector 10. In addition, the storage 150 stores software that controls an operation of the projector 10. The serial number and software are written to the storage 150 by the manufacturer when the projector 10 is manufactured.

The storage 150 also stores license information indicating a license that allows the projector 10 to be used. The license information is written to the storage 150 by a service provider after the user purchases the license. The service provider writes the license information to the storage 150, for example, using an external device 20 connected to the projector 10.

The license information is information including, for example, a serial number, usable time, and processing information. The serial number included in the license information is a serial number of the projector 10 that is allowed to be used by license. The usable time is information indicating an amount of time the projector 10 can be used. The processing information is information for processing the parameter information. The processing information is information specific to the light source device 12.

### (5-2) Acquisitor 151

The acquisitor 151 acquires various types of information. For example, the acquisitor 151 acquires license information transmitted from the external device 20. The acquisitor 151 also acquires the parameter information from the storage 121 of the light source device 12. The acquisitor 151 also acquires a light emission request from the operation device 11.

### (5-3) Determiner 152

The determiner 152 determines whether to execute writing of the license information to the storage 150. The determiner 152 checks whether a serial number included in the license information acquired by the acquisitor 151 matches a serial number stored in the storage 150. When the serial numbers match, it can be said that the projector 10 that has the license information written thereto is correct. In this case, the determiner 152 determines to write the license information to the storage 150. On the other hand, when the serial numbers do not match, it can be said that the projector 10 that has written the license information is not correct. In this case, the determiner 152 determines not to write the license information to the storage 150.

In addition, the determiner 152 determines whether the projector 10 is usable based on the license information. For example, when there is a light emission request, the determiner 152 refers to the usable time of the license information stored in the storage 150, and determines to emit light when there is usable time remaining. On the other hand, when there is no usable time remaining, the determiner 152 determines not to emit light.

### (5-4) Processor 153

The processor 153 processes the parameter information stored in the storage 121 based on the processing information stored in the storage 150.

For example, the processor 153 processes the parameter information stored in advance in the storage 121 using the processing information. The parameter information stored in advance in the storage 121 and in a state before being processed by the processing information is also referred to as “pre-processing parameter information” below. The parameter information in a state after being processed by the processing information is also referred to as “post-processing parameter information” below. The processor 153 processes the post-processing parameter information stored in the storage 121 using the processing information, and processes (returns) the post-processing parameter information to the pre-processing parameter information. The pre-processing parameter information obtained by being processed using correct processing information is identical to the parameter information stored in advance in the storage 121.

As an example, when the license information is written (stored) to the storage 150 by the service provider, the processor 153 acquires the pre-processing parameter information stored in advance in the storage 121 and processes the information using the processing information included in the license information. After processing, the processor 153 overwrites the pre-processing parameter information stored in the storage 121 with the post-processing parameter information.

Moreover, when there is a request for the light source device 12 to emit light, the processor 153 returns the post-processing parameter information stored in the storage 121 to the pre-processing parameter information based on the processing information stored in the storage 150, and inputs the pre-processing parameter information to the light source control board 16.

### (5-5) Controller 154

The controller 154 controls an overall operation of the projector 10. The controller 154 is realized by, for example, causing a central processor (CPU) provided as hardware in the control board 15 to execute a program.

### (6) Light Source Control Board 16

The light source control board 16 is a board that controls an operation of the light source device 12.

As shown in FIG. 1, the light source control board 16 includes a storage 160 and a light source controller 161.

### (6-1) Storage 160

The storage 160 stores parameter information for controlling the light source device 12. For example, the storage 160 stores pre-processing parameter information input from the processor 153 of the control board 15.

### (6-2) Light Source Controller 161

The light source controller 161 controls the operation of the light source device 12. The light source controller 161 is realized by, for example, causing the CPU provided as hardware in the light source control board 16 to execute a program.

For example, the light source controller 161 controls a light emission from the light source device 12 based on the parameter information processed by the processor 153. Specifically, the light source controller 161 controls parameters of the light source device 12 that emits light so that they become parameters indicated by the pre-processing parameter information input from the processor 153 (stored in the storage 160).

### 1-2. Processing Flow

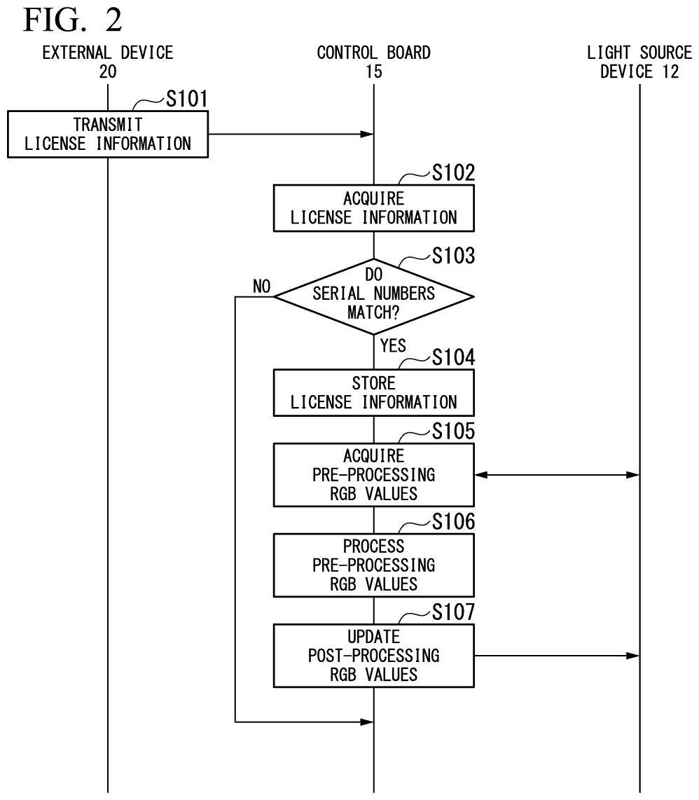

A functional configuration of the projector 10 according to the first embodiment has been described above. Next, a processing flow according to the first embodiment will be described with reference to FIGS. 2 to 9. Note that, in the following description, description of processing for a manufacturing of the projector 10 by the manufacturer, a sale of license by the service provider, and a purchase of license by the user will be omitted, and description will start with processing of registration of license information by the service provider.

(1) Processing Flow from Registration of License Information to Processing of RGB Values

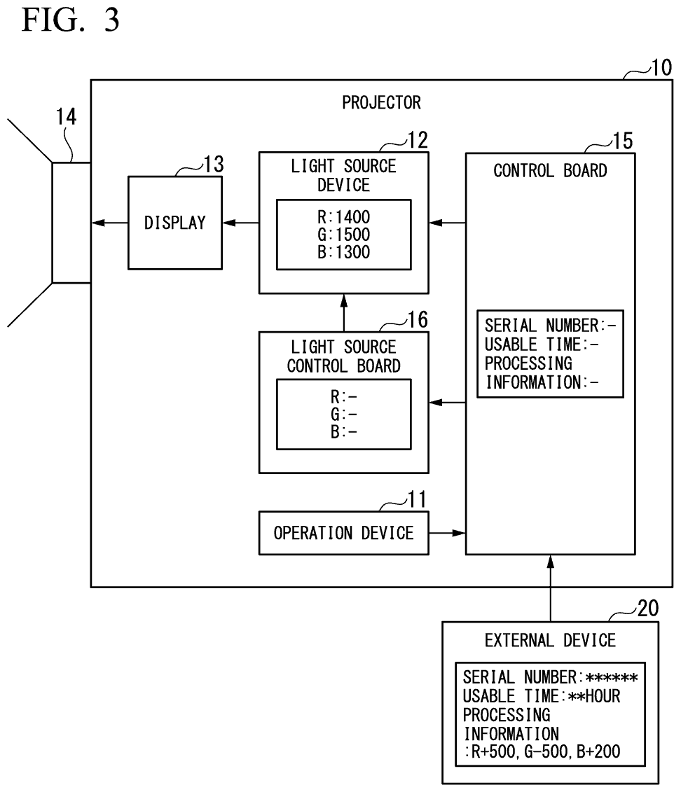

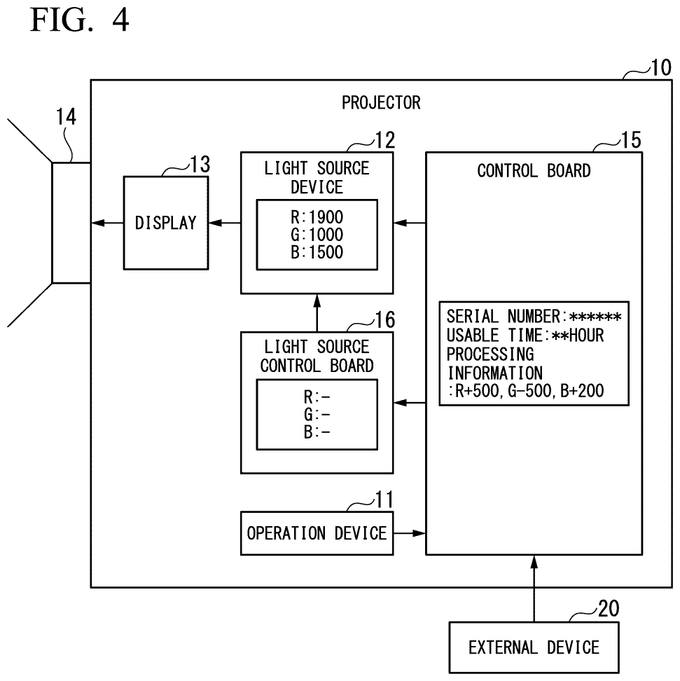

A processing flow from a registration of license information to processing of RGB values will be described with reference to FIGS. 2 to 4. FIG. 2 is a sequence diagram which shows an example of the processing flow from the registration of license information to the processing of RGB values according to the first embodiment. FIG. 3 is a diagram which shows an example of information stored in each storage in the initial state according to the first embodiment. FIG. 4 is a diagram which shows an example of information stored in each storage after the processing of RGB values according to the first embodiment.

First, the service provider uses the external device 20 to write the license information to the projector 10 in an initial state in which the user has purchased a license. As a result, as shown in FIG. 2, the license information is transmitted from the external device 20 to the control board 15 (step S101).

FIG. 3 shows the initial state of the projector 10. The initial state of the projector 10 is a state before the service provider purchases the projector 10 from the manufacturer and writes license information to the projector 10. In the initial state of the projector 10, RGB values are stored as parameter information in the storage 121 of light source device 12, and the license information of the storage 150 of the control board 15 and parameter information of the storage 160 of light source control board 16 are empty. FIG. 3 shows, as an example, an example in which R is 1400, G is 1500, and B is 1300 among the RGB values stored in storage 121 of the light source device 12. FIG. 3 also shows, as an example, an example in which the license information transmitted from the external device 20 has a serial number of “******,” a usable time of “** hours,” and processing information of “R+500, G−500, B+200.”

In the control board 15, the acquisitor 151 acquires the license information transmitted from the external device 20 (step S102).

Next, the determiner 152 checks whether the serial number included in the license information acquired by the acquisitor 151 matches the serial number stored in the storage 150 (step S103). When the serial numbers match (YES in step S103), the determiner 152 determines to write the license information to the storage 150. According to this determination, the storage 150 stores the license information (step S104). On the other hand, when the serial numbers do not match (NO in step S103), the determiner 152 determines not to write the license information to the storage 150. According to this determination, the storage 150 does not store the license information and processing ends.

After the license information is stored, the processor 153 acquires pre-processing RGB values (parameter information) from the storage 121 of the light source device 12 (step S105).

The processor 153 then processes the acquired pre-processing RGB values using the processing information (step S106). For example, the processor 153 processes the pre-processing RGB values “R: 1400, G: 1500, B: 1300” stored in the storage 121 of the light source device 12 using the processing information “R+500, G−500, B+200.” In this case, it is assumed that post-processing RGB values become “R: 1400+500=1900, G: 1500−500=1000, B: 1300+200=1500.”

After processing, the processor 153 overwrites the pre-processing RGB values stored in the storage 121 of the light source device 12 with the post-processing RGB values to update them (step S107).

FIG. 4 shows a state of the projector 10 after step S107. As shown in FIG. 4, the RGB values stored in the storage 121 of the light source device 12 are “R: 1900, G: 1000, B: 1500.” In addition, the storage 150 of the control board 15 stores license information with a serial number of “******,” usable time of “** hours,” and processing information of “R+500, G−500, B+200.” The parameter information of the storage 160 of the light source control board 16 remains empty.

(2) Processing Flow from Input of Light Emission Request to Light Emission of Light Source Device

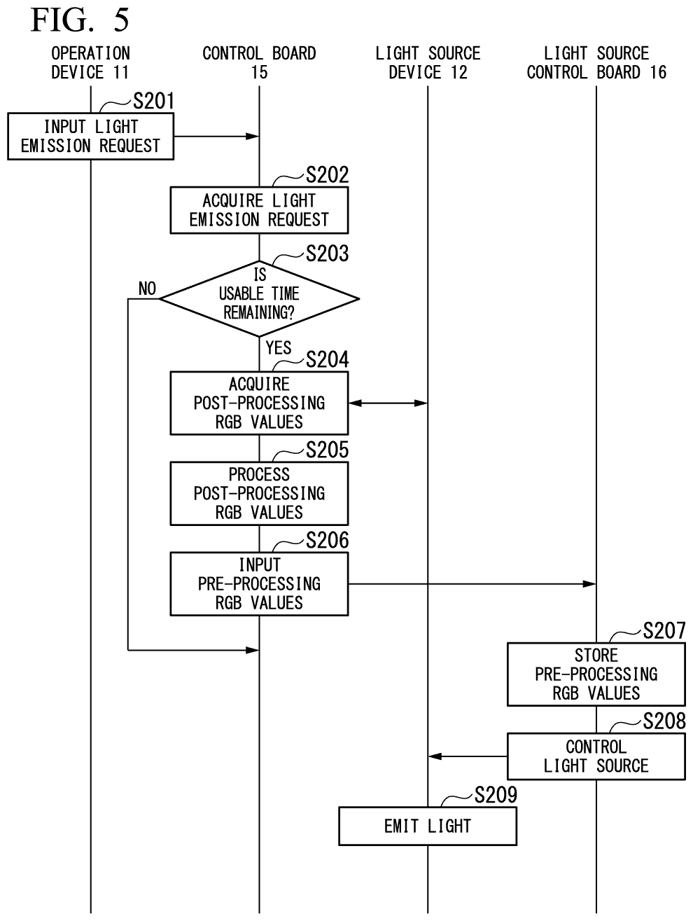

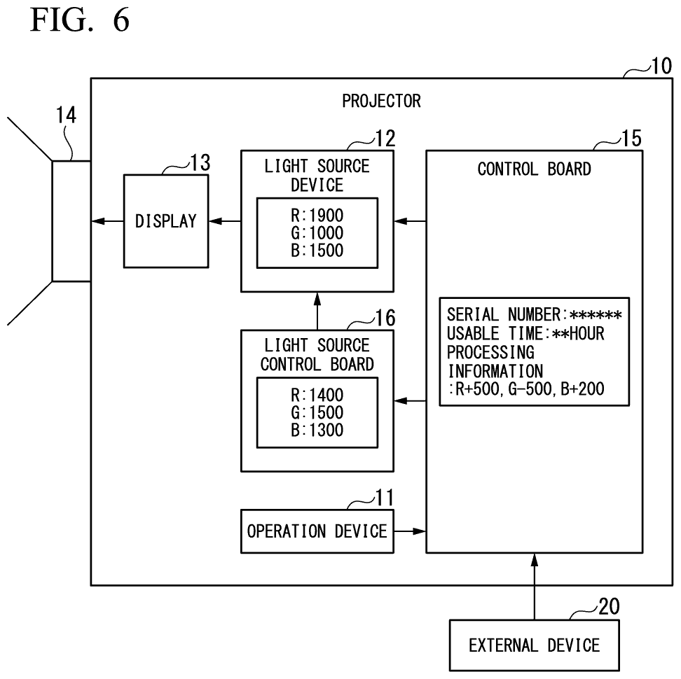

A processing flow from an input of a light emission request to a light emission of the light source device 12 will be described with reference to FIG. 5 and FIG. 6. FIG. 5 is a sequence diagram which shows an example of a processing flow from the input of a light emission request to the light emission of the light source device 12 according to the first embodiment. FIG. 6 is a diagram which shows an example of information stored in each storage when the light source device 12 emits light according to the first embodiment.

When a user who has been provided with the projector 10 in the state shown in FIG. 4 by the service provider uses the projector 10, the user inputs a light emission operation to the operation device 11 of the projector 10. As a result, as shown in FIG. 5, a light emission request is input from the operation device 11 to the control board 15 (step S201).

In the control board 15, the acquisitor 151 acquires the light emission request input from the operation device 11 (step S202).

The determiner 152 then checks whether the usable time of the license information stored in the storage 150 remains (step S203). When there is usable time remaining (YES in step S203), the determiner 152 determines to emit light and proceeds to step S204. On the other hand, when there is no usable time remaining (NO in step S203), the determiner 152 determines not to emit light and ends the processing.

When the processing proceeds to step S204, the processor 153 acquires the post-processing RGB values from the storage 121 of the light source device 12 (step S204).

The processor 153 then processes the acquired post-processing RGB values using the processing information (step S205). For example, the processor 153 returns the post-processing RGB values “R: 1900, G: 1000, B: 1500” stored in the storage 121 of the light source device 12 to the pre-processing RGB values using the processing information “R+500, G−500, B+200.” In this case, the processor 153 calculates the pre-processing RGB values as follows: “R: 1900−500=1400, G: 1000+500=1500, B: 1500−200=1300.”

After the processing, the processor 153 inputs the pre-processing RGB values to the light source control board 16 (step S206).

The storage 160 of the light source control board 16 stores the pre-processing RGB values input from the processor 153 as parameter information (step S207).

The light source controller 161 then controls the light source device 12 so that it has the pre-processing RGB values stored in the storage 160 (step S208).

The light source device 12 emits light from the light source 120 in accordance with the control of the light source controller 161 (step S209).

FIG. 6 shows the state of the projector 10 after step S209. As shown in FIG. 6, the RGB values stored in the storage 121 of the light source device 12 remain “R: 1900, G: 1000, B: 1500.” The storage 150 of the control board 15 stores license information with a serial number of “******,” usable time of “** hours,” and processing information of “R+500, G−500, B+200.” The RGB values stored in the storage 160 of the light source control board 16 are “R: 1400, G: 1500, B: 1300.”

(3) Processing Flow after Replacement of Control Board

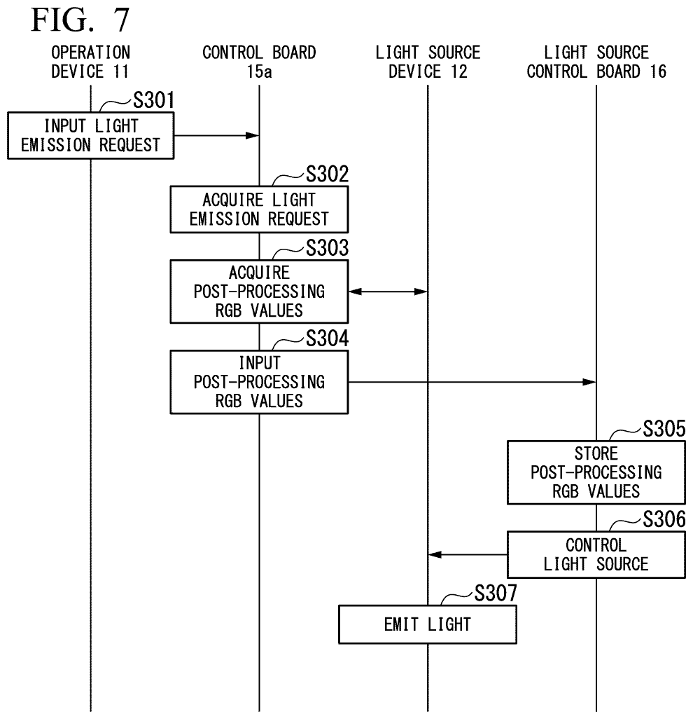

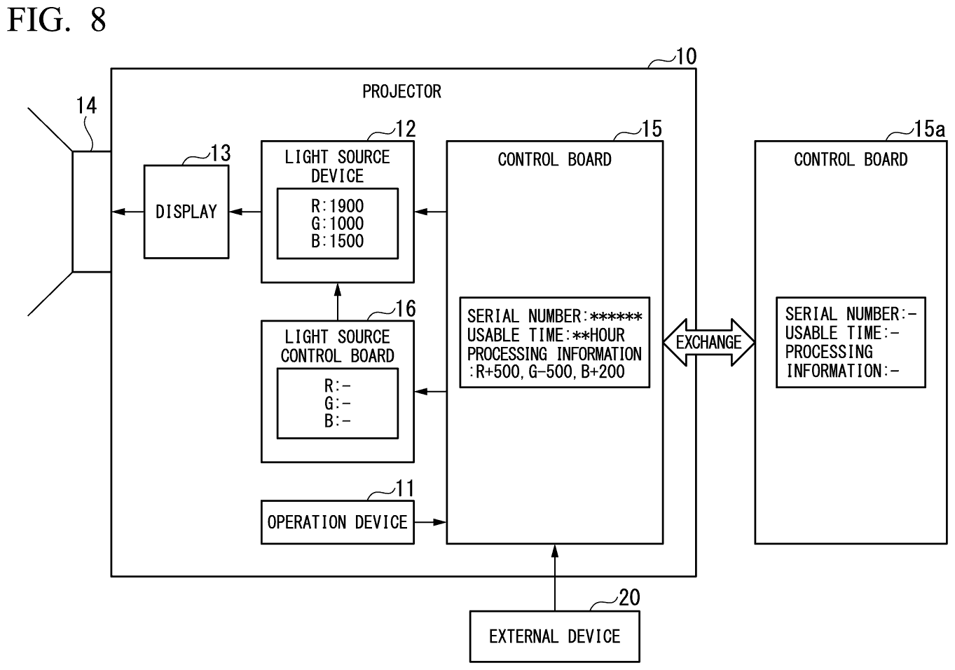

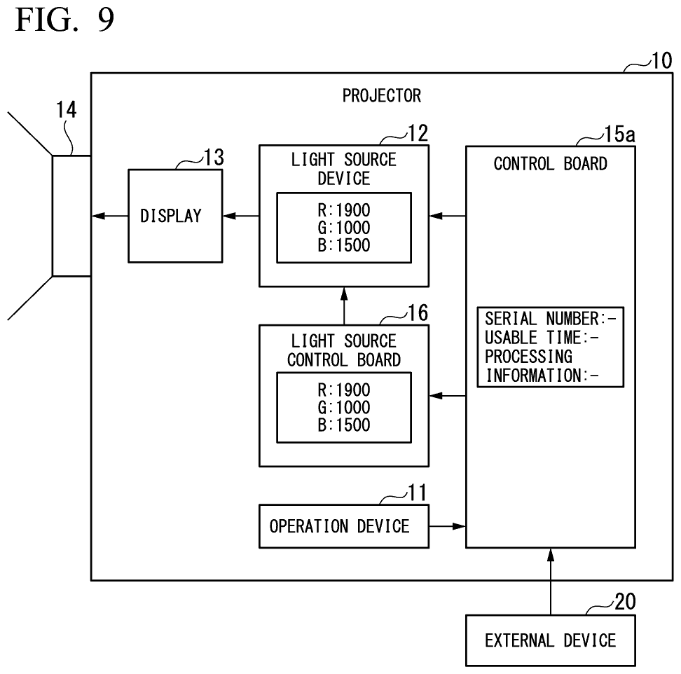

A processing flow after replacement of the control board 15 will be described with reference to FIGS. 7 to 9. FIG. 7 is a sequence diagram which shows an example of a processing flow from an input of a light emission request to light emission of the light source device 12 after replacement of the control board 15 according to the first embodiment. FIG. 8 is a diagram which shows an example of information stored in each storage when the control board 15 is replaced according to the first embodiment. FIG. 9 is a diagram which shows an example of information stored in each storage when the control board 15 is replaced according to the first embodiment and then the light source device 12 emits light.

A user who has been provided with the projector 10 in the state shown in FIG. 4 by the service provider replaces the control board 15 with a control board 15a with no software or serial information as shown in FIG. 8 before using the projector 10. In other words, it is assumed that the user has illegally replaced the control board 15. After the replacement, the user inputs a light emission operation to the operation device 11 of the projector 10. As a result, a light emission request is input from the operation device 11 to the control board 15a as shown in FIG. 7 (step S301).

In the control board 15a, the acquisitor 151 acquires the light emission request input from the operation device 11 (step S302).

Note that, unlike the control board 15, the control board 15a does not store software and license information, and therefore does not check the usable time or process RGB values.

For this reason, the control board 15a acquires the post-processing RGB values from the storage 121 of the light source device 12 (step S303) and inputs the acquired post-processing RGB values to the light source control board 16 as they are (step S304).

The storage 160 of the light source control board 16 stores the post-processing RGB values input from the control board 15a as parameter information (step S305).

The light source controller 161 then controls the light source device 12 so that it has the post-processing RGB values stored in the storage 160 (step S306).

The light source device 12 emits light from the light source 120 in accordance with the control of the light source controller 161 (step S307).

FIG. 9 shows the state of the projector 10 after step S307. As shown in FIG. 9, the RGB values stored in the storage 121 of the light source device 12 remain as “R: 1900, G: 1000, B: 1500.” The license information of the control board 15a is empty. The RGB values stored in the storage 160 of the light source control board 16 are “R: 1900, G: 1000, B: 1500.”

In this manner, when the control board 15 is illegally replaced, the light source control board 16 controls the light source device 12 so that it has the post-processing RGB values. As a result, the light source device 12 cannot output light of a correct color. As a result, the projector 10 cannot output images normally.

Note that in FIGS. 7 to 9, an example is described in which the control board 15 is replaced with a control board 15a on which software and license information are not written, but the present invention is not limited to such an example. For example, it is assumed that the control board 15 is replaced with a control board on which software and license information are written. In this case, the license information contains processing information (that is, incorrect processing information) that is different from processing information specific to the light source device 12. For this reason, a processor of the replaced control board cannot correctly return the post-processing RGB values to the pre-processing RGB values, and the light source control board 16 controls the light source device 12 so that the RGB values are not correct. For this reason, the light source device 12 cannot output light of a correct color. As a result, the projector 10 cannot output an image normally.

As described above, the projector 10 according to the first embodiment includes a storage 121 (a first storage) that stores post-processing parameter information obtained by processing parameter information indicating parameters for the light source device 12 to appropriately emit light, a storage 150 (a second storage) that stores the processing information specific to the light source device 12, a processor 153 that processes the post-processing parameter information stored in the storage 121 into pre-processing parameter information based on the processing information stored in the storage 150, and a light source controller 161 that causes the light source device 12 to emit light based on the pre-processing parameter information processed by the processor 153.

With such a configuration, in the projector 10 according to the first embodiment, when the storage 150 has not been replaced, a combination of the storage 121 in which the post-processing parameter information is stored and the storage 150 in which the processing information (license information) is stored is correct. In other words, the processor 153 is in a state in which it can correctly return the post-processing parameter information to the pre-processing parameter information. For this reason, the light source controller 161 can cause the light source device 12 to output light of an appropriate color, and the projector 10 can output an image normally. On the other hand, when the storage 150 is replaced, in the projector 10, a combination of the storage 121 in which the post-processing parameter information is stored and the replaced storage is incorrect. In other words, the processor 153 is in a state where it cannot correctly return the post-processing parameter information to the pre-processing parameter information. For this reason, the light source controller 161 cannot cause the light source device 12 to output the light of an appropriate color, and the projector 10 cannot output an image normally.

In this manner, since the projector 10 cannot output an image normally when the storage 150 in which the license information is stored is replaced, the user cannot use the projector 10 illegally by replacing the storage 150.

Therefore, the projector 10 according to the first embodiment makes it possible to prevent unauthorized use of the projector 10.

### 1-3. Modified Example

Next, modified examples of the first embodiment will be described. Each modified example described below may be applied to the first embodiment alone, or may be applied to the first embodiment in combination with each other. Each modified example may be applied in place of the configuration described in the first embodiment, or may be applied in addition to the configuration described in the first embodiment.

In the first embodiment described above, an example in which the projector 10 includes each of the light source device 12 and the light source control board 16 has been described, but the present invention is not limited to such an example. For example, instead of the light source device 12 and the light source control board 16, the projector 10 may include a single device or board that has both a function of the light source device 12 and a function of the light source control board 16.

Specifically, the light source device 12 and the light source control board 16 of the projector 10 shown in FIG. 1 may be a single device or board including the light source 120, the storage 121, the storage 160, and the light source controller 161. In this case, the light source device 12 and the light source control board 16 of the projector 10 shown in FIGS. 3, 4, 6, 8, and 9 are replaced with a single device or board. In addition, the light source device 12 in the sequence diagram shown in FIG. 2 and the light source device 12 and the light source control board 16 in the sequence diagrams shown in FIGS. 5 and 7 are replaced with a single device or board. The control board 15 communicates with the replaced single device or board. Moreover, the display 13 is irradiated with light from the light source 120 included in the replaced device or board.

In the first embodiment described above, an example in which parameter information is stored in the storage 121 of the light source device 12 has been described, but the present invention is not limited to such an example. For example, the parameter information may be stored in a storage provided in a constituent other than the light source device 12. However, it is preferable that the parameter information be stored in a storage provided in a constituent different from a constituent provided with the storage that stores the license information.

In the case of the configuration of the first embodiment described above, the parameter information is stored in, for example, the storage 160 of the light source control board 16. In this case, the processor 153 processes the pre-processing parameter information stored in the storage 160, not the storage 121, into the post-processing parameter information and overwrites it. When a light emission request is made, the processor 153 returns the post-processing parameter information stored in the storage 160 to the pre-processing parameter information. At this time, the storage 160 stores the pre-processing parameter information returned by the processor 153 without overwriting the post-processing parameter information stored in the storage 160. When the post-processing parameter information is overwritten with pre-processing parameters, unauthorized use becomes possible, so that by not overwriting, it is possible to prevent unauthorized use. Note that a storage other than the storage 160 may be provided for the light source control board 16, and the pre-processing parameter information returned by the processor 153 may be stored in that storage. Processing other than the processing by the processor 153 and the processing related to the storage of the pre-processing parameter information is the same as in the first embodiment described above.

Moreover, in the first embodiment described above, an example has been described in which the control board 15 of the projector 10 includes the determiner 152 and the processor 153, but the present invention is not limited to such an example. For example, the determiner 152 and the processor 153 may be provided in a constituent other than the control board 15. In the configuration of the first embodiment described above, the determiner 152 and the processor 153 are provided in, for example, one of the light source device 12 and the light source control board 16. Note that the determiner 152 and the processor 153 may also be provided in the same constituent, or in different constituents.

### Second Embodiment

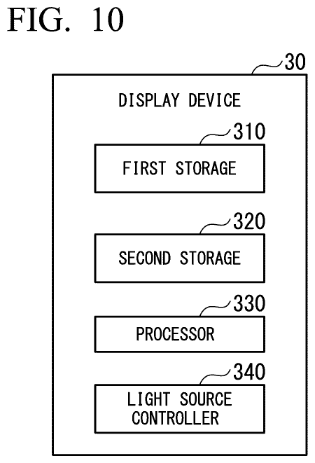

The first embodiment of the present invention has been described above. Next, a second embodiment of the present invention will be described with reference to FIG. 10. FIG. 10 is a diagram which shows an example of a configuration of a display device according to the second embodiment.

As shown in FIG. 10, the display device 30 according to the second embodiment includes a first storage 310, a second storage 320, a processor 330, and a light source controller 340.

The first storage 310 stores post-processing parameter information obtained by processing parameter information indicating parameters for the light source device to emit light appropriately.

The second storage 320 stores processing information specific to the light source device.

The processor 330 processes the post-processing parameter information stored in the first storage 310 into pre-processing parameter information based on the processing information stored in the second storage 320.

The light source controller 340 causes the light source device to emit light based on the pre-processing parameter information processed by the processor 330.

With such a configuration, in the display device 30 according to the second embodiment, when the second storage 320 has not been replaced, a combination of the first storage 310 in which the post-processing parameter information is stored and the second storage 320 in which the processing information (license information) is stored is correct. In other words, the processor 330 is in a state in which it can correctly return the post-processing parameter information to the pre-processing parameter information. For this reason, the light source controller 340 can cause the light source device to output light of an appropriate color, and the display device 30 can output an image normally. On the other hand, when the second storage 320 is replaced, in the display device 30, a combination of the first storage 310 in which the post-processing parameter information is stored and the replaced storage is incorrect. In other words, the processor 330 is in a state in which it cannot correctly return the post-processing parameter information to the pre-processing parameter information. For this reason, the light source controller 340 cannot cause the light source device to output the light of an appropriate color, and the display device 30 cannot output an image normally.

In this manner, since the display device 30 cannot output an image normally when the second storage 320 in which the license information is stored is replaced, the user cannot use the display device 30 illegally by replacing the second storage 320.

Therefore, the display device 30 according to the second embodiment makes it possible to prevent unauthorized use of the display device 30.

Each embodiment of the present invention has been described as above. Note that a part or all of the functions of the display device in each of the embodiments described above may be realized by a computer. In that case, a program for realizing this function may be recorded in a computer-readable recording medium, and the program recorded in this recording medium may be read into a computer system and executed to realize the function. Note that it is assumed that a term “computer system” herein includes an OS and hardware such as peripheral devices. In addition, a term “computer-readable recording medium” refers to a portable medium such as a flexible disk, an optical magnetic disc, an ROM, or a CD-ROM, or a storage device such as a hard disk built into a computer system. Furthermore, the term “computer-readable recording medium” may include a medium that dynamically holds a program for a short period of time, such as a communication line when a program is transmitted via a network such as the Internet or a communication line such as a telephone line, and a medium that holds a program for a certain period of time, such as a volatile memory inside a computer system that serves as a server or client in such a case. Moreover, the program described above may be a program for realizing a part of the functions described above, or may be a program that can realize the functions described above in combination with a program already recorded in the computer system, or may be a program that is realized using a programmable logic device such as a field programmable gate array (FPGA).

Although the embodiments of the present invention have been described in detail above with reference to the drawings, the specific configuration is not limited to that described above, and various design changes can be made within a range not departing from the gist of the present invention.

### REFERENCE SIGNS LIST

10 Projector
11 Operation device
12 Light source device
13 Display
14 Lens
15 Control board
15a Control board
16 Light source control board
20 External device
30 Display device
120 Light source
121 Storage
150 Storage
151 Acquisitor
152 Determiner
153 Processor
154 Controller
160 Storage
161 Light source controller
310 First storage
320 Second storage
330 Processor
340 Light source controller

1. A display device comprising:
a first storage configured to store post-processing parameter information obtained by processing parameter information indicating parameters for causing a light source device to appropriately emit light;
a second storage configured to store processing information specific to the light source device;
a processor configured to process the post-processing parameter information stored in the first storage into pre-processing parameter information based on the processing information stored in the second storage; and
a light source controller configured to cause the light source device to emit light based on the pre-processing parameter information processed by the processor.

2. The display device according to claim 1,
wherein, when the processing information is stored in the second storage, the processor overwrites the pre-processing parameter information stored in advance in the first storage with post-processing parameter information processed based on the processing information, and
returns, when a light emission request is made from the light source device, the post-processing parameter information stored in the first storage to the pre-processing parameter information and inputs the information to the light source controller based on the processing information stored in the second storage.

3. The display device according to claim 2,
wherein the light source controller performs control so that parameters of the light source device that emits light become parameters indicated by the pre-processing parameter information input from the processor.

4. The display device according to claim 1,
wherein the parameter information is RGB values set so that the light source device emits light with an appropriate white balance.

5. The display device according to claim 1,
wherein the pre-processing parameter information is the same as the parameter information.

6. The display device according to claim 1,
wherein the post-processing parameter information is a state of the parameter information after being processed by the processing information.

7. The display device according to claim 1, further comprising:
a first board that includes the second storage and the processor; and
a second board that includes the light source controller.

8. A display control method comprising:
a first storage process for storing post-processing parameter information obtained by processing parameter information indicating parameters for causing a light source device to appropriately emit light;
a second storage process for storing processing information specific to the light source device;
a processing process for processing the post-processing parameter information stored in the first storage into pre-processing parameter information based on the processing information stored in the second storage; and
a light source control process for causing the light source device to emit light based on the pre-processing parameter information processed by the processor.
